(19) United States
(12) Patent Application Publication
(10) Pub. No.: US 2015/0354624 A1
(43) Pub. Date: Dec. 10, 2015

(54) LINEAR DRIVE FORCE OVERLOAD PROTECTION DEVICE

(71) Applicant: Saint-Gobain Performance Plastics Pampus GMBH, Willich (DE)

(72) Inventor: Jens Speicher, Willich (DE)

(21) Appl. No.: 14/732,297

(22) Filed: Jun. 5, 2015

Related U.S. Application Data
(60) Provisional application No. 62/008,716, filed on Jun. 6, 2014.

(51) Int. Cl. F16C 11/06; F16H 25/12

(52) U.S. Cl. CPC F16C 11/06; F16H 25/12

(57) ABSTRACT

A tolerance ring adapted to engage a stem of a ball pan to a housing, wherein the tolerance ring is adapted to provide an overload protection against a force of greater than 1,000 N.

### CROSS-REFERENCE TO RELATED APPLICATION(S)

The present application claims priority from U.S. Provisional Patent Application No. 62/008,716, filed Jun. 6, 2014, entitled “LINEAR DRIVE FORCE OVERLOAD PROTECTION DEVICE,” naming inventor Jens Speicher, and said provisional application is incorporated by reference herein in its entirety for all purposes.

### FIELD OF THE DISCLOSURE

The present disclosure relates to linear drive assemblies, and more particularly to linear drive assemblies having a tolerance ring to provide force overload protection.

### RELATED ART

Linear drive assemblies, e.g., spindle drives, generally include a spindle portion and a drive portion, where the drive portion is associated with a drive motor. Actuation of the drive motor can linearly adjust the position of the spindle portion relative to the drive portion such that the linear drive assembly can expand in a telescopic manner. A ball pan can be associated with either or both of the spindle and drive portions. Each of the ball pans can be adapted to pivotally and rotatably engage a ball.

During operation, linear drive assemblies can be subjected to high axial and rotational loading conditions which may destroy the drive motor or the spindle portion. For example, linear drive assemblies can be utilized in vehicle tailgates. If during opening of the tailgate via the linear drive assembly, the tailgate becomes lodged or stuck, the linear drive assembly may be destroyed.

There continues to exist a need for linear drive assemblies having overload protection.

### BRIEF DESCRIPTION OF THE DRAWINGS

Embodiments are illustrated by way of example and are not intended to be limited in the accompanying figures.

FIG. 1 includes a cross-sectional side view of a ball joint assembly in accordance with an embodiment.

FIGS. 2A, 2B, and 2C each include a cross-sectional side view of a ball joint assembly in accordance with an embodiment described herein.

FIG. 3 includes a cross-sectional side view of a layer system for a ball pan as seen in Circle A of FIG. 1, in accordance with an embodiment.

FIG. 4 includes an exploded perspective view of a linear drive assembly in accordance with an embodiment.

FIG. 5 includes a perspective view of an automobile assembly in accordance with an embodiment.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the tolerance ring and linear drive arts.

A ball joint assembly in accordance with one or more of the embodiments described herein can generally include a ball pan including a stem, a housing adapted to engage the stem, and a tolerance ring disposed between the stem and the housing. In a particular embodiment, the housing can define a bore adapted to receive the stem.

A linear drive assembly in accordance with one or more of the embodiments described herein can generally include a ball pan including a stem, a linear drive adapted to engage the stem, and a tolerance ring disposed between the linear drive and the stem.

An assembly in accordance with one or more of the embodiments described herein can generally include a first member, a second member engaged with the first member, and a linear drive assembly disposed between the first and second members. In particular, the linear drive can be adapted to provide an overload protection against a force of greater than 1,000 N, such as greater than 2,000 N, greater than 3,000 N, greater than 4,000 N, or even greater than 5,000 N.

An automobile assembly in accordance with one or more of the embodiments described herein can generally include a tailgate engaged with a car body, and a linear drive assembly disposed between the tailgate and the car body. In particular, the linear drive assembly can include a ball pan including a stem, a linear drive and a tolerance ring disposed between a portion of the linear drive and the stem.

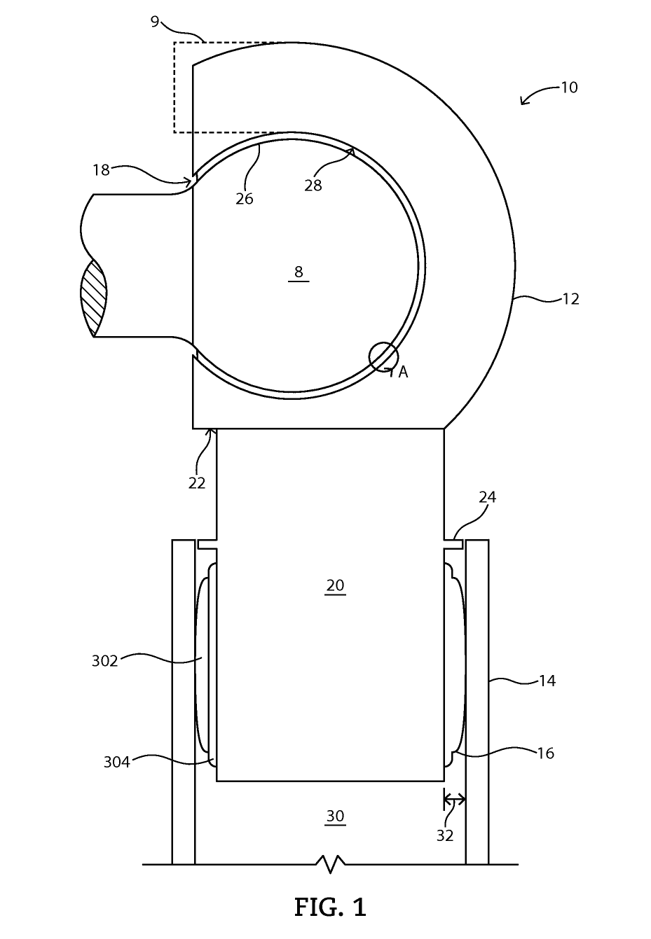

Referring now to the figures, FIG. 1 includes a cross-sectional side elevation view of a ball joint assembly 10 in accordance with an embodiment described herein. The ball joint assembly 10 generally includes a ball pan 12, a housing 14, and a tolerance ring 16.

The ball pan 12 can define an opening 18 adapted to receive a ball 8. After insertion of the ball 8 into the opening 18, the ball pan 12 can be closed so as to secure the ball 8 within the opening 18. As will be understood by a person of ordinary skill, the opening 18 can be closed by one or more methods, such as, for example, by bending one or more portions of the ball pan 12 along the opening 18 (illustrated in FIG. 1) or by attaching a securing element at one or more locations circumferentially around the opening 18. In FIG. 1, a portion 9 of the ball pan 12 is shown in an undeformed state as it may appear prior to installation and securement of the ball 8 within the opening 18 of the ball pan 12. In an embodiment, portion 9 can be mechanically deformed, e.g., bent, toward the ball 8 in order to secure the ball 8 within the opening 18. It should be understood that the embodiments described herein are not intended to be limited to the above described methods of securing the ball 8 within the opening 18.

The ball pan 12 can further include a stem 20 extending in a direction generally away from the ball 8. More specifically, in a particular embodiment, the stem 20 can extend from the ball pan 12 in an orientation generally normal, or perpendicular, to an outer surface 22 of the ball pan 12.

In a particular embodiment, the stem 20 can be unitary with the ball pan 12, e.g., the ball pan 12 and stem 20 can be formed from a single monolithic piece of material. In another embodiment, the stem 20 can include a separate component attached to an outer surface of the ball pan 12. In such a manner, the stem 20 can be secured to the ball pan 12, for example, by an adhesive, a threaded fastener, a nonthreaded fastener, welding, or a combination thereof.

In a particular embodiment, the stem 20 can have a generally smooth outer surface, e.g., the outer surface can be free of projections, notches, grooves, channels, serrations, bumps, or any combination thereof. After reading this application, those skilled in the art will understand that surface roughness, such as caused during the normal manufacturing of the stem 20, constitutes “generally smooth” as used herein. The term “smooth” as used herein can generally refer to an enhanced surface finish, for example, polished, buffed, etc. A smooth, or generally smooth, outer surface can help to facilitate precise slip characteristics of the tolerance ring 16 on the stem 20 by reducing sliding inconsistencies. In a particular embodiment, the stem 20 can be devoid of threads or other similar helical projections. In such a manner, the stem 20 can be positioned and secured within the bore 30 without requiring any relative rotation therebetween, e.g., the stem 20 can be positioned and secured within the bore 30 independent of rotation.

The stem 20 can define a functional length, L_{S}, as measured by a distance the stem 20 extends from a lowermost portion of the outer surface 22 of the ball pan 12. As used herein, the term “lowermost” is used with reference to the orientation as illustrated in FIG. 1.

The stem 20 can further include an axial stop 24. The axial stop 24 can extend from an outer surface of the stem 20. In a particular embodiment, the axial stop 24 can be adapted to prevent the tolerance ring 16 from sliding beyond a predefined axial location on the stem 20. The axial stop 24 can extend around at least a portion of a circumference of the stem 20. In a more particular embodiment, the axial stop 24 can extend continuously around the entire circumference of the stem 20. In another more particular embodiment, the axial stop 24 can include one or more axial stops circumferentially spaced apart around at least part of the circumference of the stem 20. The axial stop 24 can extend a radial distance, D_{AS}, as measured by a maximum distance the axial stop 24 extends in a radial direction from the stem 20, as measured at the location from which the axial stop 24 extends.

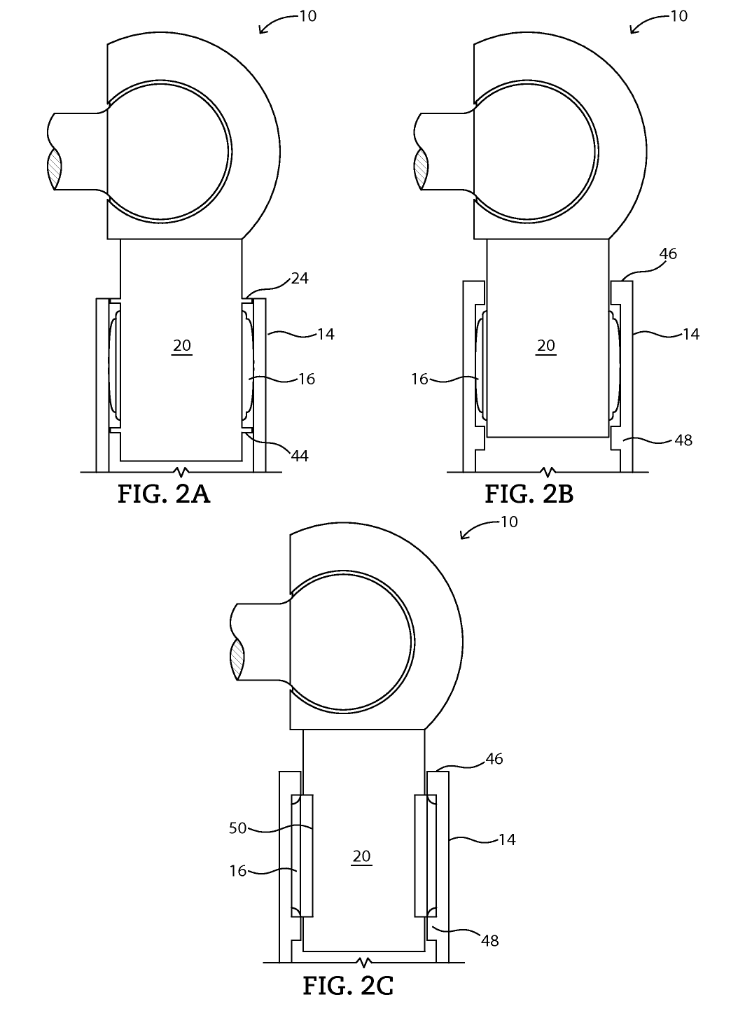

Referring now to FIG. 2A, in a particular embodiment, the stem 20 can further include an axial stop 44 extending around at least a portion of the circumference of the stem 20. More specifically, the tolerance ring 16 can be disposed between the axial stop 24 and the axial stop 44. In such a manner, any relative slip, e.g., as caused by a force overload condition, may occur between the tolerance ring 16 and the housing 14. FIG. 2B illustrates yet another embodiment, wherein the housing 14 further includes axial stops 46 and 48, each extending around at least a portion of the circumference of the housing 14. In this embodiment, the combination of axial stops 46 and 48 axially encompass the tolerance ring 16. In such a manner, any relative slip, e.g., as caused by a force overload condition, may occur between the tolerance ring 16 and the stem 20. In yet further embodiments, the axial stops 44, 46, and 48 can each include a plurality of axial stops circumferentially spaced apart around at least part of the circumferences of the stem 20 and housing 14, respectively.

As illustrated in FIG. 2C, the stem 20 can further include two axial stops 46 and 48 and a radial recess 50 extending radially inward from the outer surface thereof. In such a manner, the stem 20 can have a varying thickness along an axial length thereof. In a particular embodiment, when viewed in cross-section (such as, for example, as illustrated in FIG. 2C) the radial recesses 50 can have a polygonal configuration. In yet another non-illustrated embodiment, the radial recesses can have an arcuate cross-sectional configuration.

Referring again to FIG. 1, in accordance with one or more of the embodiments described herein, the ball pan 12 can comprise a metal, such as, for example, a steel. In a particular embodiment, a functional layer 26 can be joined to an inner surface 28 of the ball pan 12. The functional layer 26 can include, for example, an elastic layer, a support layer, a sliding layer, or any combination thereof. In a particular aspect, the functional layer 26 may allow for adjustment of the sliding and support characteristics between the ball pan 12 and the ball 8.

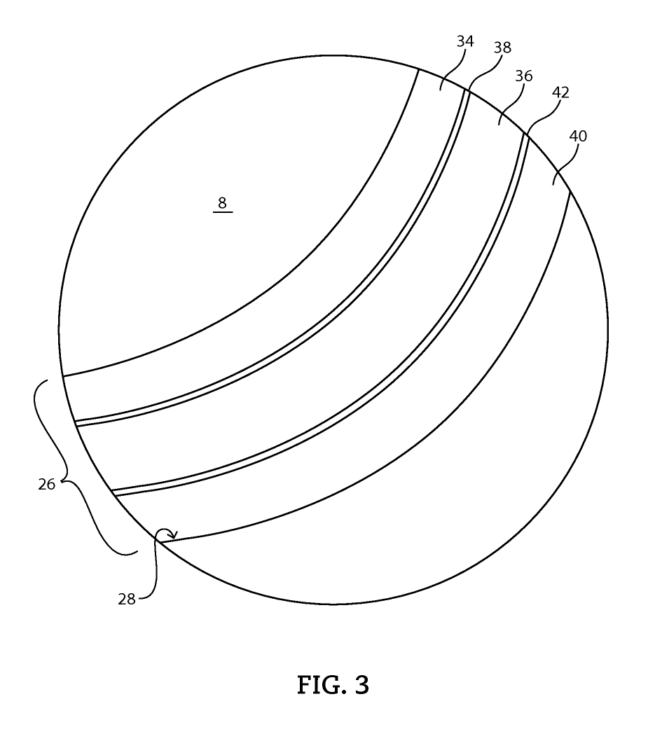

FIG. 3 illustrates a non-limiting exemplary configuration of the functional layer 26. Referring to FIG. 3, a sliding layer 34 can form a radial innermost layer of the functional layer 26 of the ball pan 12. In a certain embodiment, the sliding layer 34 can include, or essentially include, a polymer, and more particularly a low friction polymer, such as, a fluoropolymer, such as polytetrafluoroethylene (PTFE). Other exemplary fluoropolymers can include a fluorinated ethylene propylene (FEP), a polyvinylidene fluoride (PVDF), a perfluoroalkoxy (PFA), a terpolymer of tetrafluoroethylene, a hexafluoropropylene and vinylidene fluoride (THV), a polychlorotrifluoroethylene (PCTFE), an ethylene tetrafluoroethylene copolymer (ETFE), an ethylene chlorotrifluoroethylene copolymer (ECTFE), or any combination thereof. Additionally, it is possible to use a large number of other sliding materials, such as for example, those marketed by the applicant under the trademark Norglide®.

In yet a further embodiment, a lubricant can be disposed on, or within, the sliding layer 34 to further enhance relative movement between the ball pan 12 and the ball 8. Exemplary lubricants include molybdenum disulfide, tungsten disulfide, graphite, grapheme, expanded graphite, boron nitrade, talc, calcium fluoride, or any combination thereof. Additionally, the lubricant can include alumina, silica, titanium dioxide, calcium fluoride, boron nitride, mica, Wollastonite, silicon carbide, silicon nitride, zirconia, carbon black, pigments, or any combination thereof.

In particular embodiments, the sliding layer 34 can be joined to an underlying dimensionally stable support layer 36, for example, by an adhesion promoting layer or an adhesive layer 38. In a particular embodiment, the support layer 36 can consist of, or essentially of, a steel. In particular embodiments, the support layer 36 can define a thickness between 0.2 mm and 0.5 mm. The support layer 36 can be bonded to an elastic layer 40. In a particular embodiment, an adhesion promoting layer or an adhesive layer 42 can be disposed between the support layer 36 and the elastic layer 40. The elastic layer 40 is preferably an elastomer, such as, for example, a nitrile rubber. In other embodiments, the elastic layer 40 can include, or essentially include, for example, a natural or synthetic natural polyisoprene rubber, a polybutadiene, a polybutylene, a chloroprene rubber, a styrene-butadiene rubber, a hydrogenated nitrile rubber, an epichlorohydrin rubber, an ethylene acrylic rubber, an ethylene propylene diene rubber, a polyacrylic rubber, a silicone rubber, a fluorosilicone rubber, a fluroelastomer, a perfluoroelastomer, a polyether block amide, a polyphosphazene rubber, a chlorosulfonated polyethylene, a chlorinated polyethylene, an ethylene-vinyl acetate, an elastolefin, a urethane, a butyl rubber, a polyoctenylene, a polypropylene oxide rubber, a polynorbornene, or a combination thereof.

In certain embodiments, the elastic layer 40 can provide vibration dampening affects to reduce noise, vibration, and harshness exhibited during operation. Moreover, the elastic layer 40 can be prestressed. In such a manner, wear of either the support layer 36 or sliding layer 34 can be compensated for by corresponding radial expansion of the prestressed elastic layer 40. This can ensure smooth operation of the ball joint assembly 10 without any radial play throughout the service life thereof.

In a particular embodiment, the elastic layer 40 can have a thickness that is at least five times the thickness of the sliding layer 34. For example, in a particular embodiment, the thickness of the sliding layer 34 can be about 0.1 mm and the thickness of the elastic layer 40 can be about 0.5 mm. As understood by a person of ordinary skill, the functional layer 26 can include any or all of the above listed layers in any order or configuration. For example, in an alternate embodiment, the sliding layer 34 can be joined directly to the elastic layer 40.

Referring again to FIG. 1, in accordance with one or more of the embodiments described herein, the housing 14 can generally define a bore 30 having a diameter as measured between diametrically opposite locations along the sidewall thereof. The bore 30 can be adapted to receive at least a portion of the stem 20 of the ball pan 12. In a particular embodiment, the bore 30 can define a functional depth, D_{B}, as measured by a maximum distance into which a component having the radius of the stem 20 can be inserted, that is greater than or equal to L_{S}. In this regard, the stem 20 can be fully inserted into the bore 30 until the outer surface 22 of the ball pan 12 comes into contact with the housing 14.

An annular gap 32 can be formed between an outer radial surface of the stem 20 and an inner surface of the bore 30. The annular gap 32 can have a radial thickness, T_{AG}, as measured by an average radial distance from the outer radial surface of the stem 20 to the inner surface of the bore 30 when the stem 20 and bore 30 are concentrically aligned, e.g., a central axis of the bore is coaxial with a central axis of the stem.

In a particular embodiment, the bore 30 of the housing 14 can have a generally smooth inner surface, e.g., the inner surface can be free of projections, notches, grooves, channels, serrations, bumps, or any combination thereof. After reading this application, those skilled in the art will understand that surface roughness, such as caused during the normal manufacturing of the bore 30 and housing 14, constitutes “generally smooth” as used herein. The term “smooth” as used herein can generally refer to an enhanced surface finish, for example, polished, buffed, etc. A smooth, or generally smooth, inner surface can help to facilitate precise slip characteristics of the tolerance ring 16 against the housing 14 by reducing sliding inconsistencies. In a particular embodiment, the bore 30 and the housing 14 can be devoid of threads or other similar helical projections at a location where the stem 20 is to be inserted.

In an alternate embodiment, the stem can define a bore into which the housing can be inserted. In this regard, the housing can be disposed radially inside of the stem, and a tolerance ring can be disposed there between.

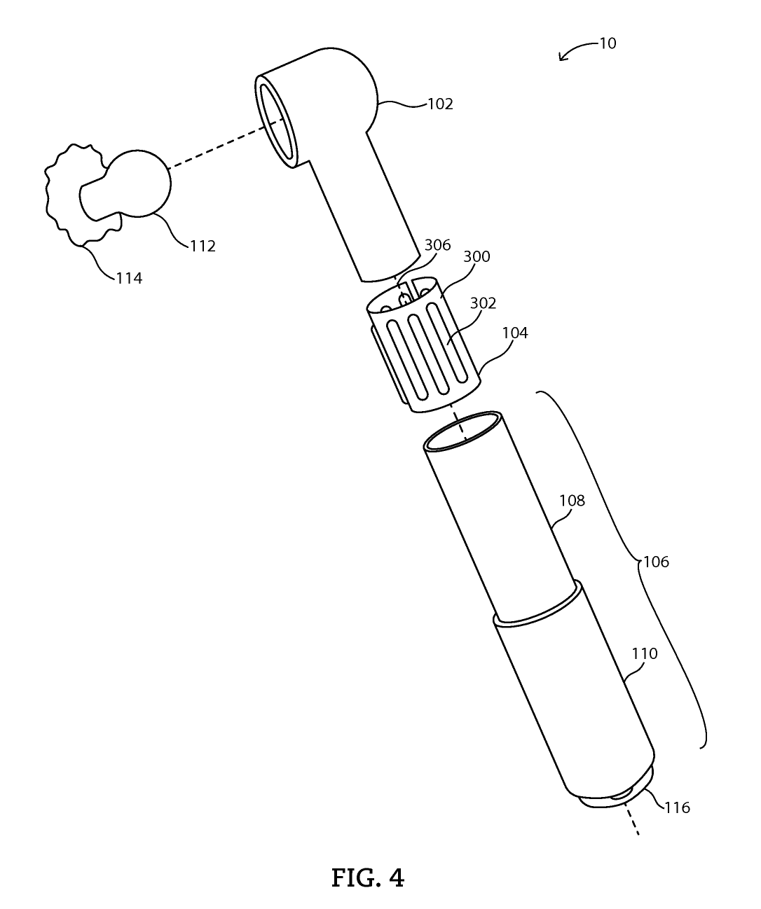

Referring to FIGS. 1 and 4, the tolerance ring 16, 104 can be disposed within the annular gap 32 and can extend between the outer radial surface of the stem 20 and the inner surface of the bore 30. In a particular embodiment, the tolerance ring 16, 104 can include an annular band 300 including a plurality of projections 302 extending therefrom. The plurality of projections 302 can extend in a radial direction, e.g., radially inward or radially outward. In a particular embodiment, each of the projections 302 can extend in a same radial direction, e.g., all projections 302 can extend radially inward or all projections can extend radially outward. In another embodiment, at least one of the projections 302 can extend radially inward and at least one of the projections 302 can extend radially outward. In an embodiment, the tolerance ring 16, 104 can include at least three projections 302 spaced circumferentially apart from one another. In further embodiments, the tolerance ring 16, 104 can include at least four projections 302, at least five projections 302, at least ten projections 302, at least twenty projections 302, or even at least fifty projections 302. In a particular instance, the projections 302 may be equally spaced apart around a circumference of the tolerance ring 16, 104.

In a particular embodiment, the projections 302 can be disposed in two or more rows extending circumferentially around the tolerance ring 16, 104. In a more particular embodiment, the projections 302 can be disposed in columns such that two or more projections are disposed in a column extending in an axial, or generally axial, direction with respect to the tolerance ring 16, 104. At least one of the columns can include two projections, three projections, four projections, five projections, six projections, seven projections, eight projections, nine projections, or even ten projections.

In a particular embodiment, the tolerance ring 16, 104 can define an axial length greater than an axial length of all of the plurality of projections. In such a manner, the tolerance ring 16, 104 can define an undeformed circumferential ring 304, e.g., a circumferential ring devoid of projections 302, extending around the circumference of the tolerance ring 16, 104 on at least one axial end thereof.

In a particular embodiment, the tolerance ring 16, 104 can define a maximum radial thickness, T_{TR}, as measured in an unassembled, e.g., uncompressed state, from a radially innermost surface to a radially outermost surface, that is greater than the thickness of the annular gap, T_{AG}. The tolerance ring 16, 104 may have a material thickness along one or more undeformed portions that is at least about 0.15 mm, at least about 0.2 mm, at least 0.25 mm, at least 0.3 mm, at least 0.35 mm, at least 0.4 mm, or even at least 0.45 mm. In an embodiment, the thickness can be no greater than 2 mm, 1.5 mm, 1 mm, or even 0.5 mm.

In a particular embodiment, at least one of the plurality of projections 302 can be adapted to operate in an elastic phase of deformation. In this regard, the at least one projection 302 can return to its original configuration and properties after receiving a deforming load characteristic. In such a manner, the tolerance ring 16, 104 can be reusable. As used herein, “reusable” refers to a tolerance ring that can be repositioned and utilized for its intended purpose after exhibiting a slip condition. A skilled artisan will understand after reading this description that it may be beneficial to replace the tolerance ring after a slip condition in order to ensure optimal operation of the assemblies as described herein.

In a particular embodiment, the tolerance ring 16, 104 can comprise a split tolerance ring, i.e., the tolerance ring 16, 104 can further include an axial gap 306 (FIG. 4) disposed along at least a portion of an axial length thereof. In particular, a split tolerance ring can facilitate easier assembly within the annular gap 32 or allow the tolerance ring 16, 104 to better compensate for varying tolerances of the annular gap 32.

In a further embodiment, the annular band of the tolerance ring 16, 104 can include a substrate and a functional outer layer disposed on at least a portion of the substrate. The functional layer can comprise a material having a coefficient of static friction different than a coefficient of static friction of the substrate material. For example, the coefficient of static friction of the functional outer layer can be greater than the coefficient of static friction of the substrate. Alternatively, the coefficient of static friction of the functional outer layer can be less than the coefficient of static friction of the substrate. In this regard, the tolerance ring 16 can be manufactured to accommodate the slip and force characteristics necessary for particular applications and assemblies.

Of course, tolerance rings having other configurations can be utilized, and the disclosure is not intended to be limited by the above, exemplary embodiments.

FIG. 4 includes an exploded perspective view of a linear drive assembly 100 in accordance with an embodiment described herein. The linear drive assembly 100 can generally include a ball pan 102, a tolerance ring 104, and a linear drive 106.

As illustrated, the linear drive 106 can further include a spindle portion 108 and a drive portion 110, where one of the drive portion 110 and spindle portion 108 can be associated with a drive motor (not illustrated). Actuation of the drive motor can linearly adjust the position of the spindle portion 108 relative to the drive portion 110 such that the linear drive assembly 100 can expand in a telescopic manner.

The linear drive 106 can engage with the ball pan 102 and can be secured thereto by the tolerance ring 104 in a manner as described above. The ball pan 102 can receive and pivotally secure a ball 112, thereby allowing the linear drive assembly 100 to pivotally and rotatably secure with a surface 114, such as, for example, a wall, a vehicle door, or any other relatively movable component.

A second engagement element 116 can extend from the linear drive 106. The second engagement element 116 can be secured to a second surface (not illustrated), allowing the linear drive assembly 100 to apply a relative force between the surface 114 and the second surface. In a particular embodiment, the second engagement element 116 can comprise a ball joint formed by a second ball pan and an associated second ball. The ball joint can engage with the linear drive with a second tolerance ring, or by direction engagement, e.g., weld, one or more fasteners (threaded or non-threaded), an adhesive, or any combination thereof. In another embodiment, the second engagement element 116 can comprise an aperture adapted to receive a bolt or other suitable fastener.

In a particular embodiment, the linear drive 106 can comprise a spindle drive. In this regard, the linear drive 106 can be: mechanically actuated, e.g., by screw, wheel and axle, or cam; hydraulically actuated; pneumatically actuated; piezoelectrically actuated; electro-mechanically actuated; or actuated by a combination thereof. In further embodiments, the linear drive 106 can include a telescoping linear actuator, e.g., a telescopic cylinder. The linear drive 106 can define a minimum axial length, L_{MIN}, and a maximum axial length, L_{MAX}. In a particular embodiment, L_{MAX}/L_{MIN} can be at least 1.25, such as at least 2.0, at least 3.0, at least 4.0, at least 5.0, or even at least 10.0. In a further embodiment, L_{MAX}/L_{MIN} can be no greater than 50, such as no greater than 40, or even no greater than 30.

Use of a tolerance ring 104 in the above described linear drive assembly 100 can offer several advantages. For example, the tolerance ring 104 can provide an adaptable force overload protection. Moreover, the overload protection can be adjusted by replacing an installed tolerance ring with a different tolerance ring having different physical and structural characteristics. Unlike threaded or pinned linear drive assemblies which statically fasten a ball pan, a linear drive assembly utilizing a tolerance ring may allow rotational alignment of the ball pan with the ball. In such a manner, alignment during manufacturing of the linear drive assembly can be easier. For example, instead of discarding unaligned linear drive assemblies or compromising their integrity, a linear drive assembly having a tolerance ring can be manipulated, e.g., rotated, by a worker performing the installation in order to align and install the linear drive assembly.

It is contemplated that a linear drive assembly in accordance with one or more of the embodiments described herein can provide an overload protection against a longitudinal force of greater than 1,000 N, greater than 2,000 N, greater than 3,000 N, greater than 4,000 N, or greater than 5,000 N while simultaneously allowing the stem or tolerance ring to rotate upon the application of no greater than 500 N, no greater than 400 Nm, no greater than 300 Nm, no greater than 200 Nm, no greater than 100 Nm, no greater than 50 Nm, no greater than 25 Nm, no greater than 20 Nm, no greater than 15 Nm, no greater than 10 Nm, no greater than 5 Nm, no greater than 4 Nm, no greater than 3 Nm, or no greater than 2 Nm. In such a manner, the assembly can provide sufficient axial rigidity, e.g., rigidity oriented in a direction substantially parallel to the central axis of the linear drive assembly, while maintaining a relatively easy assembly. In a particular instance, the linear drive assembly can have an overload protection against a longitudinal force of greater than 5,000 N while permitting the stem or tolerance ring to rotate upon application of a rotationally biasing force of no greater than 2 Nm. In a particular embodiment, the stem or tolerance ring can be rotatable about 360°.

During operation, the linear drive assembly 100 can be adapted to provide a maximum axial force, F_{LD}, less than an overload protection force, F_{OP}. In this regard, the linear drive assembly 100 can operate below a threshold force at which damage may occur. For example, F_{LD} can be less than 0.99 F_{OP}, such as less than 0.9 F_{OP}, less than 0.75 F_{OP}, or even less than 0.5 F_{OP}. In a further embodiment, F_{LD} can be greater than 0.01 F_{OP}, such as greater than 0.25 F_{OP}, or even greater than 0.45 F_{OP}.

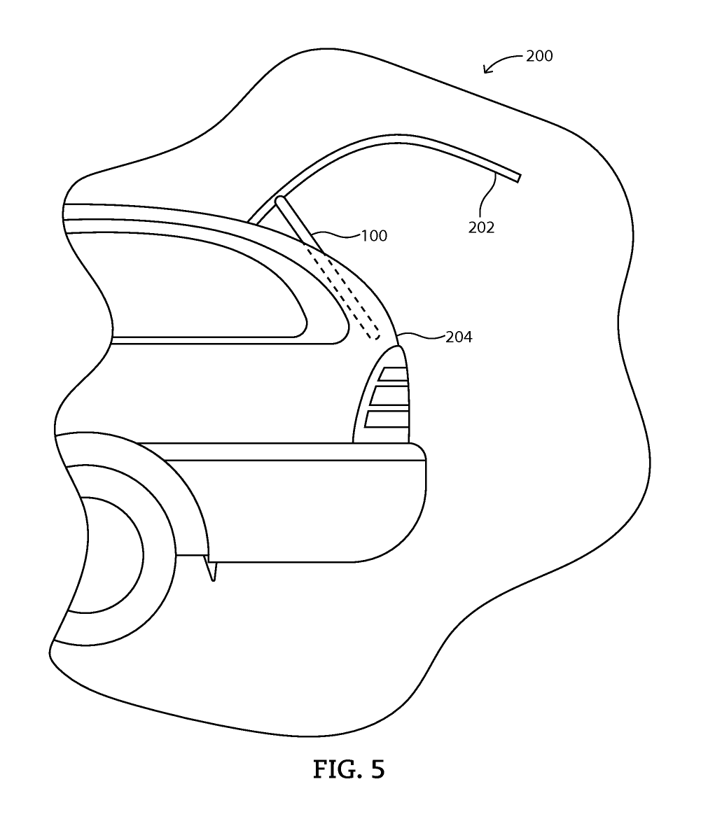

In a particular embodiment as illustrated in FIG. 5, the linear drive assembly 100 according to one or more embodiments described above can be implemented in an automobile assembly 200. For example, in a particular embodiment, the linear drive assembly 100 can be disposed between a tailgate 202 and a portion of a car body 204. In such a manner, the linear drive assembly 100 can open and close the tailgate 202 of the vehicle.

The linear drive assembly 100 can be oriented in either relative orientation and in any configuration, e.g., the spindle portion 108 or the drive portion 110 and the ball pan 102 (illustrated in FIG. 4) can engage either the tailgate 202 or the car body 204 in either configuration. Additionally, a second ball joint assembly can be formed along the spindle portion 108 or drive portion 110 between the linear drive assembly 100 and the tailgate or car body 202 and 204. In another embodiment, the linear drive assembly 100 can be utilized in a passenger door.

The linear drive assembly 100 can operate at a range of temperatures. For example, in a particular instance, the linear drive assembly 100 can have no loss of performance in a range of temperatures between −40° C. and 80° C. In another embodiment, the linear drive assembly 100 can exhibit no loss of performance between temperatures of −35° C. and 75° C., −30° C. and 70° C., −25° C. and 65° C., −20° C. and 60° C., or −15° C. and 55° C.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. A tolerance ring adapted to engage a stem of a ball pan to a housing, wherein the tolerance ring is adapted to provide an overload protection against a force of greater than 1,000 N, such as greater than 2,000 N, greater than 3,000 N, greater than 4,000 N, or even greater than 5,000 N.

Item 2. A ball joint assembly comprising:
a ball pan including a stem;
a housing adapted to engage the stem; and
a tolerance ring disposed between the stem and the housing.

Item 3. A ball joint assembly comprising:
a ball pan including a stem;
a housing defining a bore adapted to receive the stem; and
a tolerance ring disposed between the stem and the housing.

Item 4. A linear drive assembly comprising:
a ball pan including a stem;
a linear drive adapted to engage the stem;
a tolerance ring disposed between the linear drive and the stem.

Item 5. An assembly comprising:
a first member;
a second member engaged with the first member; and
a linear drive assembly disposed between the first and second members, the linear drive assembly comprising:
   a ball pan including a stem;
   a linear drive engaged with the stem; and
   a tolerance ring disposed between the linear drive and the stem,
wherein the linear drive is adapted to provide an overload protection against a force of greater than 1,000 N, such as greater than 2,000 N, greater than 3,000 N, greater than 4,000 N, or even greater than 5,000 N.

Item 6. An automobile assembly comprising:
a tailgate engaged with a car body, wherein one of the tailgate and the car body comprises a ball; and
a linear drive assembly comprising:
   a ball pan including a stem, wherein the ball pan is adapted to receive the ball;
   a linear drive having a first axial end and a second axial end, wherein the first axial end is engaged with the other one of the tailgate and the car body, and wherein the second axial end is engaged with the stem; and
   a tolerance ring disposed in an annular gap between a portion of the linear drive and the stem.

Item 7. The automobile assembly according to item 6, wherein the first axial end is pivotally engaged with the other one of the tailgate and the car body.

Item 8. The automobile assembly according to any one of items 6 and 7, wherein the ball is disposed on the tailgate and wherein the first axial end is disposed on the car body.

Item 9. The automobile assembly according to any one of items 6 and 7, wherein the ball is disposed on the car body and wherein the first axial end is disposed on the tailgate.

Item 10. The automobile assembly according to any one of items 6-9, wherein the linear drive comprises a spindle drive.

Item 11. The tolerance ring, ball joint, linear drive assembly, assembly, or automobile assembly according to any one of the preceding items, wherein the tolerance ring is adapted to provide an overload protection against a force of greater than 1,000 N, such as greater than 2,000 N, greater than 3,000 N, greater than 4,000 N, or even greater than 5,000 N.

Item 12. The tolerance ring, ball joint, linear drive assembly, assembly, or automobile assembly according to any one of the preceding items, wherein the tolerance ring is adapted to reach a slip condition prior to transmitting a damaging force to any component of the assembly.

Item 13. The tolerance ring, ball joint, linear drive assembly, assembly, or automobile assembly according to any one of the preceding items, wherein the tolerance ring defines a central axis and wherein the tolerance ring is adapted to provide an overload protection against a force oriented in a direction substantially parallel to the central axis.

Item 14. The tolerance ring, ball joint, linear drive assembly, assembly, or automobile assembly according to any one of the preceding items, wherein, when one of the stem and the tolerance ring is held static, the other of the stem and the tolerance ring is adapted to rotate upon application of a force of no greater than 500 N, such as no greater than 400 Nm, no greater than 300 Nm, no greater than 200 Nm, no greater than 100 Nm, no greater than 50 Nm, no greater than 25 Nm, no greater than 20 Nm, no greater than 15 Nm, no greater than 10 Nm, no greater than 5 Nm, no greater than 4 Nm, no greater than 3 Nm, or even no greater than 2 Nm.

Item 15. The tolerance ring, ball joint, linear drive assembly, assembly, or automobile assembly according to any one of the preceding items, wherein, when one of the stem and the tolerance ring is held static, the other of the stem and the tolerance ring is adapted to rotate upon application of a force of no less than 0.01 Nm, no less than 0.1 Nm, no less than 0.5 Nm, no less than 1 Nm, no less than 5 Nm, no less than 10 Nm, or even no less than 20 Nm.

Item 16. The tolerance ring, ball joint, linear drive assembly, assembly, or automobile assembly according to any one of the preceding items, wherein the tolerance ring comprises an annular band and a plurality of projections extending from the annular band.

Item 17. The tolerance ring, ball joint, linear drive assembly, assembly, or automobile assembly according to item 16, wherein at least one of the plurality of projections extends in a radially inward direction.

Item 18. The tolerance ring, ball joint, linear drive assembly, assembly, or automobile assembly according to any one of items 16 and 17, wherein at least one of the plurality of projections extends in a radially outward direction.

Item 19. The tolerance ring, ball joint, linear drive assembly, assembly, or automobile assembly according to any one of items 16-18, wherein all of the plurality of projections extend in a same radial direction.

Item 20. The tolerance ring, ball joint, linear drive assembly, assembly, or automobile assembly according to any one of the preceding items, wherein the tolerance ring further comprises an axial gap disposed along an axial length of the tolerance ring.

Item 21. The tolerance ring, ball joint, linear drive assembly, assembly, or automobile assembly according to any one of the preceding items, wherein the tolerance ring comprises a metal, such as spring steel.

Item 22. The tolerance ring, ball joint, linear drive assembly, assembly, or automobile assembly according to any one of the preceding items, wherein the tolerance ring further comprises a substrate and a functional outer layer disposed on at least a portion of the substrate, and wherein the functional outer layer has a coefficient of static friction different than a coefficient of static friction of the substrate.

Item 23. The tolerance ring, ball joint, linear drive assembly, assembly, or automobile assembly according to item 25, wherein the coefficient of static friction of the functional outer layer is greater than the coefficient of static friction of the substrate.

Item 24. The tolerance ring, ball joint, linear drive assembly, assembly, or automobile assembly according to item 25, wherein the coefficient of static friction of the functional outer layer is less than the coefficient of static friction of the substrate.

Item 25. The tolerance ring, ball joint, linear drive assembly, assembly, or automobile assembly according to any one of items 16-24, wherein the plurality of projections are adapted to operate in the elastic phase of deformation.

Item 26. The tolerance ring, ball joint, linear drive assembly, assembly, or automobile assembly according to any one of items 16-25, wherein the tolerance ring has an axial length, and wherein each projection of the plurality of projections has a length less than the axial length of the tolerance ring.

Item 27. The tolerance ring, ball joint, linear drive assembly, assembly, or automobile assembly according to any one of the preceding items, wherein the stem extends in an orientation normal to an outer surface of the ball pan.

Item 28. The tolerance ring, ball joint, linear drive assembly, assembly, or automobile assembly according to any one of the preceding items, wherein the stem further comprises a recessed portion adapted to receive a portion of the tolerance ring, and wherein a radius of the recessed portion is less than a radius of an other portion of the stem.

Item 29. The tolerance ring, ball joint, linear drive assembly, assembly, or automobile assembly according to item 28, wherein, when viewed in cross section, the recess has a polygonal configuration.

Item 30. The tolerance ring, ball joint, linear drive assembly, assembly, or automobile assembly according to any one of the preceding items, wherein the stem further comprises an axial stop adapted to prevent the tolerance ring from sliding beyond a predefined location.

Item 31. The tolerance ring, ball joint, linear drive assembly, assembly, or automobile assembly according to any one of the preceding items, wherein an outer surface of the stem is devoid of threads.

Item 32. The tolerance ring, ball joint, linear drive assembly, assembly, or automobile assembly according to any one of the preceding items, wherein an outer surface of the stem is generally smooth.

Item 33. The tolerance ring or ball joint according to any one of items 1-3 and 11-32, wherein the housing comprises a linear drive.

Item 34. The tolerance ring or ball joint according to any one of items 1-3 and 11-33, wherein the housing defines a bore adapted to receive the stem, and wherein the bore has an inner diameter that is greater than an outer diameter of the stem so as to form an annular gap between an inner surface of the bore and an outer surface of the stem.

Item 35. The tolerance ring or ball joint according to any one of items 1-3 and 11-33, wherein the stem defines a bore adapted to receive the housing, and wherein the stem has an inner diameter that is greater than an outer diameter of the housing so as to form an annular gap between an inner surface of the stem and an outer surface of the housing.

Item 36. The tolerance ring or ball joint according to any one of items 1-3 and 11-35, wherein the housing is devoid of threads.

Item 37. The linear drive assembly, assembly, or automobile assembly according to any one of items 4-33, wherein the linear drive defines a bore adapted to receive the stem, and wherein the bore has an inner diameter that is greater than an outer diameter of the stem so as to form an annular gap between an inner surface of the bore and an outer surface of the stem.

Item 38. The linear drive assembly, assembly, or automobile assembly according to any one of items 4-33, wherein the stem defines a bore adapted to receive the linear drive, and wherein the bore has an inner diameter that is greater than an outer diameter of the linear drive so as to form an annular gap between an inner surface of the bore and an outer surface of the linear drive.

Item 39. The tolerance ring, ball joint, linear drive assembly, assembly, or automobile assembly according to any one of items 34-38, wherein the annular gap has a thickness, T_{AG}, wherein the tolerance ring has a thickness, T_{TR}, as measured in the unassembled state, and wherein T_{TR} is greater than T_{AG}.

Item 40. The linear drive assembly, assembly, or automobile assembly according to any one of items 4-33 and 37-39, wherein the linear drive is devoid of threads.

Item 41. The tolerance ring, ball joint, linear drive assembly, assembly, or automobile assembly according to any one of the preceding items, wherein the stem is devoid of threads.

Item 42. The tolerance ring, ball joint, linear drive assembly, assembly, or automobile assembly according to any one of the preceding items, wherein the stem is generally smooth.

Item 43. The tolerance ring, ball joint, linear drive assembly, assembly, or automobile assembly according to any one of the preceding items, wherein the ball pan has a unitary construction.

Item 44. The tolerance ring, ball joint, linear drive assembly, assembly, or automobile assembly according to any one of the preceding items, wherein at least a part of an inner portion of the ball pan further comprises:
a sliding layer containing a sliding material;
a support layer;
an elastic layer; or
a combination thereof.

Item 45. The tolerance ring, ball joint, linear drive assembly, assembly, or automobile assembly according to item 44, wherein the sliding layer includes a polymer.

Item 46. The tolerance ring, ball joint, linear drive assembly, assembly, or automobile assembly according to any one of items 44 and 45, wherein the sliding layer contains lubricants or lubricating fillers.

Item 47. The tolerance ring, ball joint, linear drive assembly, assembly, or automobile assembly according to any one of items 44-46, wherein a thickness of the sliding layer is between 0.02 mm and 2.0 mm.

Item 48. The tolerance ring, ball joint, linear drive assembly, assembly, or automobile assembly according to any one of items 44-47, wherein the support layer is arranged between the sliding layer and the elastic layer.

Item 49. The tolerance ring, ball joint, linear drive assembly, assembly, or automobile assembly according to any one of items 44-48, wherein the sliding layer is bonded to the support layer by an adhesive layer.

Item 50. The tolerance ring, ball joint, linear drive assembly, assembly, or automobile assembly according to any one of items 44-48, wherein the elastic layer is bonded to the sliding layer by an adhesive layer.

Item 51. The tolerance ring, ball joint, linear drive assembly, assembly, or automobile assembly according to any one of items 49 and 50, wherein the adhesive layer is at least one of a fluoropolymer, cured adhesive, or a mixture thereof.

Item 52. The tolerance ring, ball joint, linear drive assembly, assembly, or automobile assembly according to any one of items 44-51, wherein a thickness of the elastic layer is between 0.05 mm and 2.0 mm.

Item 53. The tolerance ring, ball joint, linear drive assembly, assembly, or automobile assembly according to any one of items 44-52, wherein a thickness of the support layer is between 0.05 mm and 2.0 mm.

Item 54. The tolerance ring, ball joint, linear drive assembly, assembly, or automobile assembly according to any one of items 44-53, wherein the support layer consists of a metal, a bearing foil consisting of a woven metal fabric and PTFE, or a composite material consisting of a PTFE film and a bronze expanded metal.

Item 55. The tolerance ring, ball joint, linear drive assembly, assembly, or automobile assembly according to any one of items 4-33 and 37-54, wherein the linear drive comprises a spindle drive.

Item 56. The tolerance ring, ball joint, linear drive assembly, assembly, or automobile assembly according to any one of items 4-33 and 37-55, wherein the linear drive is adapted to provide a biasing force to a tailgate or a side door of a vehicle.

Item 57. The tolerance ring, ball joint, linear drive assembly, assembly, or automobile assembly according to any one of items 4-33 and 37-56, wherein the linear drive is adapted to generate a maximum axial force, F_{LD}, less than an overload protection force, F_{OP}, of the linear drive.

Item 58. The tolerance ring, ball joint, linear drive assembly, assembly, or automobile assembly according to item 57, wherein F_{LD} is less than 0.99 F_{OP}, such as less than 0.9 F_{OP}, less than 0.75 F_{OP}, or even less than 0.5 F_{OP}.

Item 59. The tolerance ring, ball joint, linear drive assembly, assembly, or automobile assembly according to any one of items 57 and 58, wherein F_{LD} is greater than 0.01 F_{OP}, such as greater than 0.25 F_{OP}, or even greater than 0.5 F_{OP}.

Item 60. The tolerance ring, ball joint, linear drive assembly, assembly, or automobile assembly according to any one of items 4-33 and 37-59, wherein the spindle drive is electrically powered.

Item 61. The tolerance ring, ball joint, linear drive assembly, assembly, or automobile assembly according to any one of items 4-33 and 37-59, wherein the spindle drive is hydraulically powered.

Item 62. A method of assembling a linear drive assembly, comprising:
providing a ball pan having a stem extending from an outer surface thereof;
positioning a tolerance ring around the stem; and
positioning the stem into a bore of a linear drive.

Item 63. The method according to item 62, wherein positioning the stem into the bore is performed such that the stem is slid axially into the bore of the linear drive.

Item 64. The method according to any one of items 62 and 63, wherein positioning the stem into the bore is performed such that neither the stem nor the linear drive are rotated.

### Examples

A first sample, sample S1, includes a housing having an inner diameter of 9.48 mm and an outer diameter of 12.6 mm, a solid, cylindrical shaft having an outer diameter of 8.315 mm, and a tolerance ring having a diameter of 9.5 mm and a width of 12 mm with a material thickness of 0.15 mm. The tolerance ring is formed from stainless steel, having a hardness of approximately 425 VPN. The initial wave height of the tolerance ring, i.e., prior to installation between the shaft and housing, is 0.75 mm.

A second sample, Sample S2, includes a housing and tolerance ring having dimensions as described above with respect to Sample S1. The shaft is a solid, cylindrical shaft having an outer diameter of 8.422 mm.

A third sample, Sample S3, includes a housing and tolerance ring having dimensions as described above with respect to Samples S1 and S2. The shaft is a solid, cylindrical shaft having an outer diameter of 8.519 mm.

The samples were each assembled, with the tolerance ring disposed between the shaft and the housing. Table 1 illustrates the relative assembly and disassembly force for all three samples.

TABLE 1
Assembly and Disassembly Forces

| | | | Initial Tolerance | | Assembly | Disassembly |
|---|---|---|---|---|---|---|
| | Shaft OD | Housing ID | Ring Wave Height | Compression | Force | Force |
| Sample | (mm) | (mm) | (mm) | Ratio of Wave | (N) | (N) |
| 1 | 8.315 | 9.48 | 0.75 | 22% | 930 | 394 |
| 2 | 8.422 | 9.48 | 0.75 | 29% | 1251 | 300 |
| 3 | 8.519 | 9.48 | 0.75 | 36% | 1539 | 303 |

As illustrated, Sample 1 has the lowest assembly force (930 N) and the highest disassembly force (394 N).

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

1. A tolerance ring adapted to engage a stem of a ball pan to a housing, wherein the tolerance ring is adapted to provide an overload protection against a force of greater than 1,000 N.

2. The tolerance ring according to claim 1, wherein, when one of the stem and the tolerance ring is held static, the other of the stem and the tolerance ring is adapted to rotate upon application of a force of no greater than 50 Nm.

3. The tolerance ring of claim 1, wherein, when one of the stem and the tolerance ring is held static, the other of the stem and the tolerance ring is adapted to rotate upon application of a force of no greater than 5 Nm.

4. The tolerance ring of claim 1, wherein the tolerance ring further comprises a substrate and a functional outer layer disposed on at least a portion of the substrate, and wherein the functional outer layer has a coefficient of static friction different than a coefficient of static friction of the substrate.

5. A ball joint assembly comprising:
a ball pan including a stem;
a housing adapted to engage the stem; and
a tolerance ring disposed between the stem and the housing.

6. The ball joint according to claim 5, wherein the tolerance ring is adapted to reach a slip condition prior to transmitting a damaging force to any component of the assembly.

7. The ball joint according to claim 5, wherein the stem further comprises a recessed portion adapted to receive a portion of the tolerance ring, and wherein a radius of the recessed portion is less than a radius of an other portion of the stem.

8. The ball joint according to claim 1, wherein an outer surface of the stem is devoid of threads, the housing is devoid of threads, or a combination thereof.

9. An assembly comprising:
a first member;
a second member engaged with the first member; and
a linear drive assembly disposed between the first and second members, the linear drive assembly comprising:
a ball pan including a stem;
a linear drive engaged with the stem; and
a tolerance ring disposed between the linear drive and the stem,
wherein the linear drive is adapted to provide an overload protection against a force of greater than 1,000 N.

10. The assembly according to claim 9, wherein the tolerance ring is adapted to reach a slip condition prior to transmitting a damaging force to any component of the assembly.

11. The assembly according to claim 9, wherein the tolerance ring defines a central axis and wherein the tolerance ring is adapted to provide an overload protection against a force oriented in a direction substantially parallel to the central axis.

12. The assembly according to claim 9, wherein, when one of the stem and the tolerance ring is held static, the other of the stem and the tolerance ring is adapted to rotate upon application of a force of no greater than 50 Nm.

13. The assembly according to claim 9, wherein the tolerance ring further comprises a substrate and a functional outer layer disposed on at least a portion of the substrate, and wherein the functional outer layer has a coefficient of static friction different than a coefficient of static friction of the substrate.

14. The assembly according to claim 9, wherein the stem further comprises a recessed portion adapted to receive a portion of the tolerance ring, and wherein a radius of the recessed portion is less than a radius of another portion of the stem.

15. The assembly according to claim 9, wherein the stem further comprises an axial stop adapted to prevent the tolerance ring from sliding beyond a predefined location.

16. The assembly according to claim 9, wherein an outer surface of the stem is devoid of threads.

17. The assembly according to claim 9, wherein the housing is devoid of threads.

18. The assembly according to claim 9, wherein at least a part of an inner portion of the ball pan further comprises:
a sliding layer containing a sliding material;
a support layer;
an elastic layer; or
a combination thereof.

19. The assembly according to claim 9, wherein the linear drive comprises a spindle drive.

20. The assembly according to claim 9, wherein the linear drive is adapted to generate a maximum axial force, F_{LD}, less than an overload protection force, F_{OP}, of the linear drive.
